(19) United States
(12) Patent Application Publication
(10) Pub. No.: US 2005/0242281 A1
(43) Pub. Date: Nov. 3, 2005

(54) Unevenly segmented multipole

(76) Inventor: Gangqiang Li, Palo Alto, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/837,205

(22) Filed: Apr. 30, 2004

(51) Int. Cl. H01J 49/42

(52) U.S. Cl. 250/292; 250/282

(57) ABSTRACT

An unevenly segmented multipole is described. A mass spectrometer employing the unevenly segmented multipole is provided, as well as methods of analyzing ions by mass spectrometry using the unevenly segmented multipole.

### FIELD OF THE INVENTION

The invention relates generally to multipole devices such as quadrupoles, which are useful in analysis of ions, and other applications. More specifically, the invention relates to segmented multipoles.

### BACKGROUND OF THE INVENTION

Mass spectrometry systems are analytical systems used for quantitative and qualitative determination of the compositions of materials, which include chemical mixtures and biological samples. In general, a mass spectrometry system uses an ion source to produce electrically charged particles (e.g., molecular or polyatomic ions) from the material to be analyzed. Once produced, the electrically charged particles are introduced to the mass spectrometer and separated by mass analyzer based on their respective mass-to-charge ratios. The abundance of the separated electrically charged particles are then detected and a mass spectrum of the material is produced. The mass spectrum provides information about the mass-to-charge ratio of a particular compound in a mixture sample and, in some cases, information about the molecular structure of that component in the mixture.

For determining molecular weight of a compound, mass spectrometry systems employing a single mass analyzer are widely used. These analyzers include a quadrupole (Q) mass analyzer, a time-of-flight mass analyzer (TOFMS), ion trap (IT-MS), and etc. For more complicated molecular structure analysis, however, tandem mass spectrometers (Tandem-MS or MS/MS) are often needed. Tandem mass analyzers typically consist of two mass analyzer of the same or of different types, for instance TOF-TOF MS or Q-TOF MS. In a tandem MS analysis, ionized particles are sent to the first mass analyzer and an ion of particular interest is selected. The selected ion is typically transmitted to a collision cell where the selected ion is fragmented. The fragment ions are transmitted to the second mass analyzer for mass analysis. The fragmentation pattern obtained from the second mass analyzer can be used to determine the structure of the corresponding molecules.

For example, in a triple quadrupole mass spectrometer an ionization source produces a plurality of parent ions. The first quadrupole is used as a mass analyzer to select a particular parent ion. Then, the selected parent ion is dissociated into daughter ions in the second quadrupole via photodissociation and/or collisionally induced dissociation. Subsequently, the third quadrupole is used as a mass analyzer to separate the daughter ions based on their respective mass-to-charge ratios. The resulting mass spectrum can be used to identify the daughter ions, which can be useful in identifying the structure of the selected parent ion.

In the example described above, the second quadrupole can be used as a collision cell to facilitate collision induced dissociation of the selected parent ion. In such a collision cell, the selected parent ions are sent into an RF quadrupole field which is pressurized up to approximately 1 to 10 mbar with a background gas (normally an inert gas such as argon). When the parent ions collide with the background gas, a portion of the translation energy of the parent ions is converted into activation energy that is sufficiently high to break certain molecular bonds to form daughter ions. The RF quadrupole field facilitates confinement of the daughter ions and the remaining parent ions until further mass analysis. The fragment pattern produced characterizes the original molecule and provides information about its structure.

In combination with other ion optic elements, an RF quadrupole can also be used as an ion trap for storage of ions. A potential gradient is formed along the axis of the quadrupole, and ions are trapped in a potential well. The ion trapping provides a possibility for performing ion accumulation, charge reduction, and ion-ion chemistry. In some tandem mass spectroscopy applications, an ion collision cell/linear ion trap is also used as a mass selective device. A molecular ion of a given mass is selected, isolated, and stored. Ion-gas collisions and/or ion-ion reactions are then performed.

When the quadrupole is used as a linear ion trap or as a collision cell, specific potential distributions are formed along the axis of the quadrupole. In a linear ion trap, a potential well is formed for confining ions (which may be either positively or negatively charged). The potential well typically is formed by using a quadrupole with gate electrodes at each end of the quadrupole. Holding the gate electrodes at a relatively “high” potential (at “trapping potential”) and the quadrupole at a relatively “low” potential provides the potential well that confines the ions. In a collision cell, a potential gradient is necessary for accelerating ions along the axis of the quadrupole. This potential distribution is typically formed by using an evenly segmented quadrupole and applying a DC potential gradient to the different segments of the quadrupole.

Each of the described uses of a quadrupole structure in a mass spectrometer is dependent upon the application of specific RF and/or DC potentials to manipulate the ions. What is needed is a quadrupole that provides for the needed RF and/or DC potential distributions.

### SUMMARY OF THE INVENTION

The invention addresses the aforementioned technology, and provides a multipole useful for, e.g. manipulating ions in a mass spectrometer, wherein the multipole has segments of differing length. The multipole includes a rod set having 2N rods, where N is an integer selected from the range of 2 to about 8. The rods are disposed around a long axis of the multipole. Each rod includes a rod-shaped support and a plurality of conductive segments disposed along the rod-shaped support. The conductive segments are separated from each other by non-conductive areas of the rod-shaped support. In particular embodiments, at least one of the segments of each rod is relatively long compared to the remaining segments. In some embodiments, two or even three of the segments are relatively long compared to the other remaining segments. For a multipole having length L, a relatively long segment typically has a length in the range from about 14% L to about 90% L. In certain embodiments, at least three of the segments of each rod are relatively short compared to the relatively long segments. A relatively short segment typically has a length in the range from about 1% L to about 12% L. In some embodiments, at least four of the segments of each rod are relatively short. In certain embodiments, at least five of the segments of each rod are relatively short. Each segment is adapted to be in electrical communication with a potential source for applying a DC potential, an RF potential, or both to the segment, thereby producing a potential distribution for manipulating ions in a mass spectrometer. In a typical embodiment, the segments on each rod of the rod set are disposed similarly on each of the rods such that the pattern of relatively long segments and relatively short segments is the same for each rod.

In a particular embodiment, N is 2 and the multipole is a quadrupole. In another embodiment, N is 3 and the multipole is a hexapole. In yet another embodiment, N is 4 and the multipole is an octopole. In still another embodiment, N is 5 and the multipole is a decapole. In another embodiment, N is 8 and the multipole is denoted a “16-pole”.

The invention further provides a mass spectrometer which includes such a multipole and methods of analyzing ions in a mass spectrometer using such a multipole. A method in accordance with the invention includes obtaining a sample, ionizing the sample to provide ions, directing the ions into a multipole having at least four segments, wherein the segments include at least one relatively long segment and at least three relatively short segments. The method in accordance with the invention further includes applying potentials to the segments of the multipole to manipulate ions in the mass spectrometer, thereby resulting in manipulated ions, and detecting the manipulated ions.

Additional objects, advantages, and novel features of this invention shall be set forth in part in the descriptions and examples that follow and in part will become apparent to those skilled in the art upon examination of the following specifications or may be learned by the practice of the invention. The objects and advantages of the invention may be realized and attained by means of the instruments, combinations, compositions and methods particularly pointed out in the appended claims.

### BRIEF DESCRIPTION OF THE DRAWINGS

These and other features of the invention will be understood from the description of representative embodiments of the method herein and the disclosure of illustrative apparatus for carrying out the method, taken together with the Figures, wherein

FIG. 1 schematically illustrates a mass spectrometer as is known in the art.

FIG. 2 depicts an unevenly segmented quadrupole rod set in accordance with the present invention.

FIG. 3 shows an end-on view of the four rods of the quadrupole of FIG. 2.

FIG. 4 depicts one embodiment of an unevenly segmented quadrupole.

FIG. 5 illustrates an embodiment of an unevenly segmented quadrupole.

FIG. 6 shows another embodiment of an unevenly segmented quadrupole.

To facilitate understanding, identical reference numerals have been used, where practical, to designate corresponding elements that are common to the Figures. Figure components are not drawn to scale.

### DETAILED DESCRIPTION

Before the invention is described in detail, it is to be understood that unless otherwise indicated this invention is not limited to particular materials, reagents, reaction materials, manufacturing processes, or the like, as such may vary. It is also to be understood that the terminology used herein is for purposes of describing particular embodiments only, and is not intended to be limiting. It is also possible in the present invention that steps may be executed in different sequence where this is logically possible. However, the sequence described below is preferred.

It must be noted that, as used in the specification and the appended claims, the singular forms “a,” “an” and “the” include plural referents unless the context clearly dictates otherwise. Thus, for example, reference to “a segment” includes a plurality of segments. Similarly, a “set” of an item as recited in the description includes embodiments where the set includes a single item and also embodiments in which a plurality of the items are in the set.

### DETAILED DESCRIPTION OF EMBODIMENTS

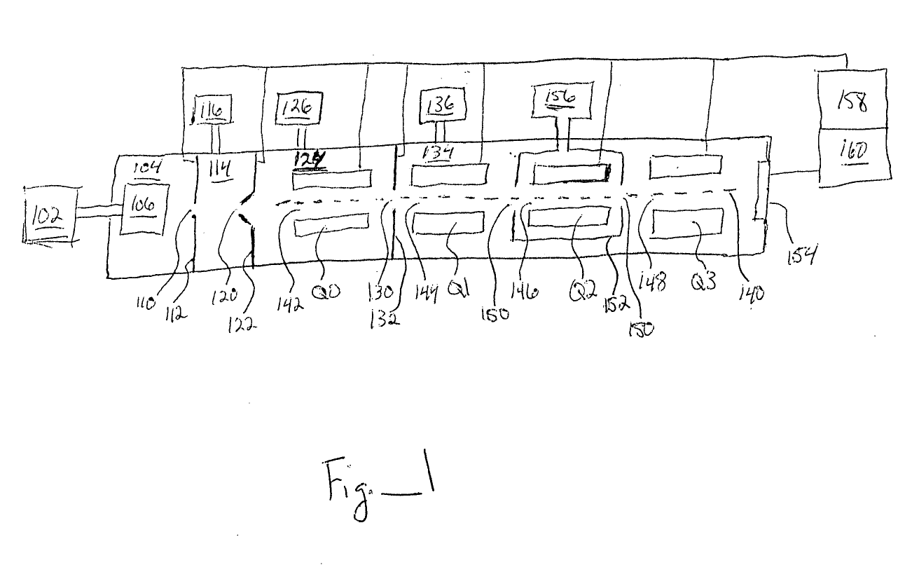

Referring now to FIG. 1, a mass spectrometer 100 typical of that known in the art is described. Mass spectrometer 100 includes a conventional sample source 102, which can be a liquid chromatograph, a gas chromatograph, or any other desired source of sample. From sample source 102, a sample is conducted via interface tube 108 to an ion source 106 which ionizes the sample. Ion source 106 can be (depending on the type of sample) an electrospray or ion spray device, or it can be a corona discharge needle (if the sample source is a gas chromatograph), or it can be a plasma, or it can be any other ion source suitable for providing ions to be analyzed in the mass spectrometer 100. Various ion sources are described in U.S. Pat. Nos. 4,935,624, 4,861,988, and 4,501,965.

Ion source 106 is located in chamber 104. From ion source 106, ions are directed through an orifice 110 in orifice plate 112 and into a first stage vacuum chamber 114 pumped e.g. to a pressure of about 1 torr by a vacuum pump 116. The ions then travel through a skimmer opening 120 in a skimmer 122 and into a vacuum chamber 124. Vacuum chamber 124 is pumped e.g. down to a pressure of about 1 to about 10 millitorr by pump 126, and a further vacuum chamber 134 is pumped e.g. to a pressure of about 10\hat{ }−5 millitorr to about 10\hat{ }−4 millitorr by pump 136. An orifice 130 in plate 132 connects vacuum chambers 124, 134.

Mass spectrometer 100 contains four sets of quadrupole rods, indicated as Q0, Q1, Q2 and Q3. The four sets of rods extend tandem to each other along a common central axis 140 and are spaced slightly apart end to end so that each defines an elongated interior volume 142, 144, 146, 148. Rod set Q2 has collision gas from a collision gas source 156 injected into its interior volume 146 and is largely enclosed in a grounded metal case 152, to maintain adequate gas pressure (e.g. about 8 millitorr) therein. Apertures 150 in the metal case 152 permit entry and exit of ions.

Appropriate RF and DC potentials are applied to opposed pairs of rods of the rod sets Q0 to Q3, and to the various ion optical elements 112, 122, and 132 by a power supply 158 which is part of a controller 160. Appropriate DC offset voltages are also applied to the various rod sets by power supply 158. A detector 154 detects ions transmitted through the last set of rods Q3.

In use, normally a RF potential is applied to rod set Q0, plus a DC rod offset voltage which is applied uniformly to all the rods. This rod offset voltage delivers the electric potential inside the rod set (the axial potential). Because the rods have conductive surfaces, and the rod offset potential is applied uniformly to all four rods, the potential is constant throughout the length of the rod set, so that the electric field in an axial direction is zero (i.e. the axial field is zero). Rod set Q0 acts as an ion transmission device, transmitting ions axially therethrough while permitting gas entering rod set Q0 from orifice 120 to be pumped away. Therefore the gas pressure in rod set Q0 can be relatively high, particularly when chamber 104 is at atmospheric pressure. The gas pressure in rod set Q0 is in any event kept fairly high to obtain collisional focusing of the ions, e.g. it can be about 8 millitorr. By way of typical example, the offsets applied may be in the range from about 100 to about 1,000 volts DC on plate 112, 0 volts on the skimmer 122, and −20 to −30 volts DC offset on Q0 (this may vary depending on the ions of interest).

The rod offsets for Q1, Q2 and Q3 depend on the mode of operation, as is well known. Rod set Q1 normally has both RF potential and DC potential applied to it, so that it acts as an ion filter, transmitting ions of desired mass (or in a desired mass range), as is conventional. Rod set Q2 typically has an RF potential applied to it, plus (as mentioned) a rod offset voltage which defines the electric potential in the volume 144 of the rod set. The rod offset voltage is used to control the collision energy in an MS/MS mode, where Q2 acts as a collision cell, fragmenting the parent ions transmitted into it through rod sets Q0 and Q1.

The daughter ions formed in the collision cell constituted by rod set Q2 are scanned sequentially through rod set Q3, to which both RF potential and DC potential are applied. Ions transmitted through rod set Q3 are detected by detector 154. The detected signal is processed and stored in memory and/or is displayed on a screen and printed out.

A multipole according to the present invention includes a rod set having 2N rods, where N is an integer in the range 2 to about 8, typically in the range from 2 to 4. In a particular embodiment, N is 2 and the multipole is a quadrupole. In another embodiment, N is 3 and the multipole is a hexapole. In yet another embodiment, N is 4 and the multipole is an octopole. In still another embodiment, N is 5 and the multipole is a decapole. In another embodiment, N is 8 and the multipole is denoted a 16-pole. In the embodiments described in the figures, herein, the multipoles described are quadrupoles; however, it will be appreciated that multipoles having features described herein may have more than four rods and such multipoles are within the scope of the invention.

Each rod in a multipole according to the present invention typically has a rod-shaped support and a plurality of conductive segments (sometimes referenced herein as just “segments”) disposed along the rod-shaped support. The plurality of conductive segments of each rod typically includes one relatively long segment, although in some embodiments, two relatively long segments may be included, or, in some embodiments three relatively long segments are included. In certain embodiments four relatively long segments are included. For a multipole having length L (measured as the length of a rod from tip to opposing tip along the long axis of the rod), a relatively long segment typically has a length in the range from about 14% L to about 90% L, or, in certain embodiments, in the range from about 14% to about 75%, or, in certain embodiments, in the range from about 14% to about 60%, or, in some embodiments, in the range from about 14% to about 45%. In certain embodiments, at least three of the segments of each rod are relatively short segments (compared to the relatively long segments). In some embodiments, at least four of the segments of each rod are relatively short segments (compared to the relatively long segments). In certain embodiments according to the present invention, each rod of the multipole includes at least five relatively short segments, or at least six relatively short segments, or at least seven relatively short segments, or at least eight relatively short segments. A relatively short segment typically has a length in the range from about 1% L to about 10% L, or, in certain embodiments, a relatively short segment has a length in the range from about 2% to about 8%.

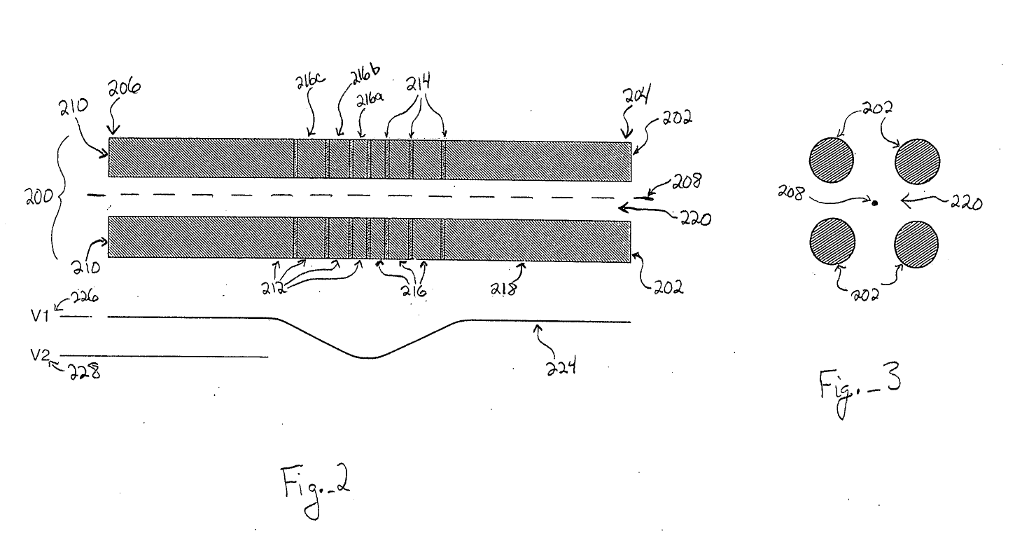

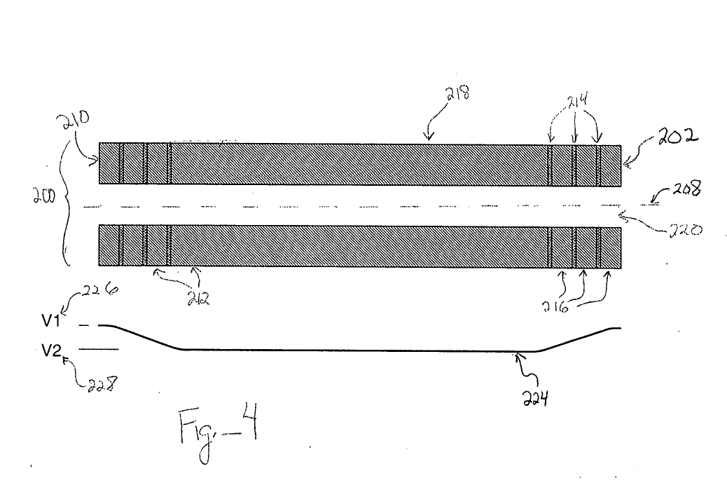

Referring now to FIGS. 2 through 6, various embodiments of a multipole according to the present invention for manipulating ions in a mass spectrometer are described. FIG. 2 illustrates an unevenly segmented quadrupole rod set 200 in accordance with the present invention. The rod set 200 includes four rods 202 arranged substantially parallel to each other and to a center axis 208 of the quadrupole. FIG. 3 depicts an end-on view of the four rods 202, and shows that the four rods 202 are arranged around the center axis 208 in the usual manner of a quadrupole. “Substantially parallel”, as used herein to describe the orientation of rods in a multipole means that the rods are either parallel or arranged at a slight angle (e.g. less than about 10 degrees, or less than about 5 degrees, with respect to each other). The purpose of the slight angle, if present, is to allow an axial field to be applied to ions in the quadrupole during use, as described in U.S. Pat. No. 5,847,386 to Thomson et al. As noted above, the rods are substantially parallel and may be arranged at a slight angle with respect to each other and/or with respect to the center axis of the quadrupole. In some embodiments, the rods may be tapered or otherwise shaped to provide for modified field distributions that facilitate ion manipulation. The rod set defines an interior volume 220 within the quadrupole, through which ions move during typical operation of the quadrupole.

Continuing with FIG. 2, each rod 202 has two opposing ends, an inlet end 206 and an outlet end 204. Each rod typically has a rod-shaped support 210 and a plurality of conductive segments 212 disposed in tandem along the rod 202. The conductive segments are separated from each other by non-conductive gaps 214 disposed between the conductive segments 212. The non-conductive gaps 214 generally include an electrical insulator disposed between the adjacent conductive segments 212. The lengths of the conductive segments 212 vary along a given rod 202. For example, each rod in the quadrupole depicted in FIG. 2 includes a plurality of relatively short segments 216 (typical embodiments have, e.g at least three, at least four, at least five, at least six, at least seven, or at least eight short segments) and one or more relatively long segments 218 (e.g. two or more; further e.g. three or more, or four or more). In the embodiment of FIG. 2, there are relatively short segments 216a which are shorter than other relatively short segments 216b, which are shorter than still other relatively short segments 216c, such that there are three different lengths of relatively short segments. In particular embodiments there are segments of at least three different lengths; in various embodiments there are segments of at least four different lengths, or even five or more different lengths.

In a typical embodiment, the segments on each rod of the rod set are disposed similarly on each of the rods such that the pattern (spatial configuration, or format) of relatively long segments and relatively short segments is the same for each rod. Typically, each rod in the multipole will have up to about ten conductive segments, in some instances up to about a dozen, or up to about 15, more typically up to about 20, or up to about 25, or in some embodiments up to about 30 conductive segments, or even more.

As shown in FIG. 2, the lengths of the segments are not equal. In this embodiment, the segments in the central section of the quadrupole are shorter than the segments away from the center. This finer spacing of the segments is placed especially at the section where ions are trapped. The shorter segments allow a finer and smoother potential distribution for ion trapping and manipulating. This embodiment is particularly used to trap ions in a specific location, e.g. at which ion-ion chemistry is to be performed. In such an embodiment, the potential at various points along the length of the quadrupole is illustrated schematically by trace 224, showing the field at low potential V2 228 and at higher potential V1 226 elsewhere along the quadrupole.

In typical embodiments, the number and format of conductive segments 212 will typically be selected based on desired operational characteristics of the multipole (e.g. quadrupole). In this regard, “unevenly segmented” references a rod, rod set, or multipole comprising a rod set that has both relatively long conductive segments and relatively short conductive segments. Having different length conductive segments provides the opportunity to shape the potential fields used for manipulating ions in the multipoles of the present invention. This may provide advantages in manipulating ions. The selection and configuration of rods sets with conductive segments will be based on design and desired performance characteristics of the device employing the unevenly segmented multipoles of the present invention. In theory, it is advantageous if the segments of the quadrupole are made short, i.e., there are more segments in a given collision cell/linear ion trap length. Short segments would allow a more finely adjustable, more continuous potential distribution with the quadrupole. However, short segments also require more skill (and more cost) to manufacture, e.g. more electrical connection and isolation of segments and components is necessary. So the actual number of the segments is typically a compromise between performance and cost. On the other hand, a non-segmented quadrupole is desired if it is used as a mass filter: a non-segmented quadrupole provides better performance (resolution, transmission) and is less complicated to manufacture in comparison to one of segmented. Given the disclosure herein, those of ordinary skill in the art will be able to build and use unevenly segmented multipoles according to the current invention without undue experimentation. In particular embodiments of unevenly segmented quadrupoles according to the present invention, the quadrupole is only segmented where a specific potential distribution is required due to design and function considerations.

Each conductive segment 212 is adapted to be in electrical communication with a potential source for applying a DC potential, an RF potential, or both to the conductive segment, thereby producing a potential distribution for manipulating ions in a mass spectrometer. Each conductive segment 212 is in communication with a potential source in a manner well known in the art to provide a potential to the conductive segment during operation of the quadrupole. In certain embodiments, two or more conductive segments may be electrically connected via, e.g. a direct connection, resistor(s), capacitor(s), or other method well known in the art to reduce the complexity of the overall apparatus (e.g. to reduce the number/complexity of power supply(ies)).

Rods may be made by depositing or otherwise forming a layer of metal on a rod-shaped support. The support may be any suitable material or combination of materials that provides a non-conductive surface for the metal layer, such as ceramic. The metal layer may be formed over the full length of the rod and then portions removed to give the conductive segments. Another method involves forming metal bands or rings in the desired format to give the conductive segments; subsequent removal of material is then unnecessary. Any other suitable method of manufacture of the rods may be used, such as is known in the art.

It will be apparent to one of skill in the art given the disclosure herein that quadrupoles having unevenly segmented rods in accordance with the present invention will be useful in a variety of mass spectrometers which employ quadrupoles. A mass spectrometer such as the one shown in FIG. 1 may employ one or more quadrupoles having unevenly segmented rods. Construction and use of such a mass spectrometer is within ordinary skill in the art given the disclosure herein. The invention thus provides a mass spectrometer which includes a multipole according to the present invention.

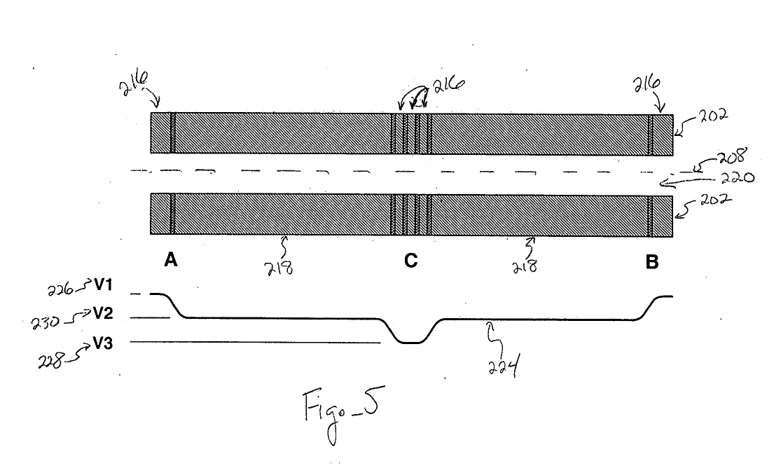

One embodiment of an unevenly segmented quadrupole is shown in FIG. 4. In FIG. 4, each of the rods 202 of the quadrupole has a plurality of short segments 216 disposed at each end of said rod and a single long segment 218 disposed between the short segments. As indicated by trace 224, higher potentials are applied to the segments at the ends of the rods 202 so ions are trapped in the middle section of the quadrupole. In this embodiment, trapping potentials can be radio frequency voltages so ions can be reflected back and forth between the segments disposed at the ends of the rods. This operation mode is designed to increase ion-ion collision and trapping efficiency due to a large trapping volume.

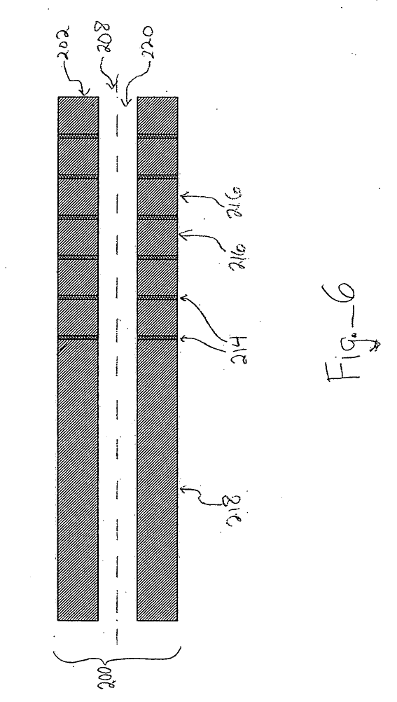

Another embodiment, shown in FIG. 5, has relatively short segments 216 at the ends of the rods 202 (at “A” and at “B”) and in the middle of the rods 202 (at “C”). A relatively long segment 218 is disposed between the relatively short segment 216 at “A” and at “C”. Another relatively long segment 218 is disposed between the relatively short segment 216 at “B” and at “C”. The configuration shown provides an ion trap with an additional potential well at the center of the quadrupole, allowing ions in the trap to be concentrated/focused in the central potential well.

In another embodiment, one end of the quadrupole has a series of relatively short segments 216 as shown in FIG. 6; the other end of the quadrupole has a single relatively long segment 218 and is used as a mass filter. In use, ions are sent to the mass filter and are mass/charge selected and then sent to the portion of the quadrupole that has the relatively short segments for fragmentation/ion-ion reaction/accumulation. This embodiment permits high resolution ion selection and fragmentation using single quadrupole.

The invention further provides methods of analyzing ions in a mass spectrometer using such a multipole. A method in accordance with the invention includes obtaining a sample, ionizing the sample to provide ions, directing the ions into a multipole having at least four segments per rod, wherein the at least four segments include at least one relatively long segment and at least three relatively short segments. The method in accordance with the invention further includes applying potentials to the segments of the multipole to manipulate ions in the mass spectrometer, thereby resulting in manipulated ions, and detecting the manipulated ions. The manipulation of the ions can include such processes as, e.g. mass selection, ion-ion reaction, fragmentation, collisional focusing, ion transport, collision induced dissociation, charge reduction, and other techniques of ion manipulation in multipoles as known in the art, and combinations thereof.

The practice of the present invention will employ, unless otherwise indicated, conventional techniques of analytical chemistry, analytical instrumentation design, and mass spectrometry instruments and methods, and the like, which are within the skill of the art. Such techniques are explained fully in the literature.

The examples described herein are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C. and pressure is at or near atmospheric. Standard temperature and pressure are defined as 20° C. and 1 atmosphere.

While the foregoing embodiments of the invention have been set forth in considerable detail for the purpose of making a complete disclosure of the invention, it will be apparent to those of skill in the art that numerous changes may be made in such details without departing from the spirit and the principles of the invention. Accordingly, the invention should be limited only by the following claims.

All patents, patent applications, and publications mentioned herein are hereby incorporated by reference in their entireties.

1. A multipole having length L, the multipole comprising:
a rod set having 2N rods, wherein N is an integer from 2 to 8, wherein each rod comprises a rod-shaped support and a plurality of conductive segments disposed along the rod-shaped support, wherein at least one of the conductive segments of each rod has a length in the range from about 14% L to about 90% L, and wherein at least three of the conductive segments of each rod have lengths in the range from about 1% L to about 12% L.

2. A multipole according to claim 1, wherein at least two of the plurality of conductive segments of each rod have lengths in the range from about 14% L to about 75% L.

3. A multipole according to claim 1, wherein at least three of the plurality of conductive segments of each rod have lengths in the range from about 14% L to about 60% L.

4. A multipole according to claim 1, wherein at least four of the plurality of conductive segments of each rod have lengths in the range from about 1% L to about 12% L.

5. A multipole according to claim 1, wherein at least five of the plurality of conductive segments of each rod have lengths in the range from about 1% L to about 12% L.

6. A multipole according to claim 1, wherein N is selected from 2, 3, or 4 and the multipole is a quadruple, hexapole, or octopole, respectively.

7. A multipole according to claim 1, wherein the multipole has a center axis and the rods are disposed around the center axis, the rods being substantially parallel to each other and to the center axis.

8. A multipole according to claim 1, further comprising non-conductive areas disposed between the conductive segments.

9. A multipole according to claim 1, wherein the conductive segments of each rod are disposed similarly to the conductive segments of each of the other rods such that the pattern of relatively long conductive segments and relatively short conductive segments is the same for each rod.

10. A mass spectrometer comprising a multipole according to claim 1.

11. A method of analyzing ions in a mass spectrometer comprising a multipole according to claim 1, the method comprising
a) obtaining a sample,
b) ionizing the sample to provide ions,
c) directing the ions into the multipole according to claim 1, wherein the multipole has at least four conductive segments disposed along each rod, wherein the conductive segments include at least one relatively long segment and at least three relatively short segments,
d) applying potentials to the conductive segments of the multipole to manipulate ions in the mass spectrometer, thereby resulting in manipulated ions, and
e) detecting the manipulated ions.

12. The method of claim 11 wherein the manipulation of ions includes one or more manipulations selected from the group consisting of mass selection, ion-ion reaction, fragmentation, collisional focusing, ion transport, collision induced dissociation, and charge reduction.
